(19) United States
(12) Patent Application Publication
(10) Pub. No.: US 2008/0097718 A1
(43) Pub. Date: Apr. 24, 2008

(54) INTERFACING APPARATUS AND METHOD FOR MOUNTING SENSORS ON THE SAME

(75) Inventor: Matthew Allen Nelson, Gardnerville, NV (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/551,541

(22) Filed: Oct. 20, 2006

(51) Int. Cl. H02B 1/00

(52) U.S. Cl. 702/127; 361/600; 361/679; 361/728

(57) ABSTRACT

Disclosed is an interfacing apparatus including an interfacing structure, at least one association region defined by the interfacing structure, the at least one association region configured for association with a sensor association region of at least one sensor, at least one electrical contact region disposed with the interfacing structure, the at least one electrical contact region being configured for electrical association with an electrical sensor contact region of the at least one sensor, a connector disposed with the interfacing structure, the connector configured for connection to a monitoring device, and a signal router disposed in the interfacing structure, the signal router configured to electrically associate the at least one electrical contact region with the connector.

### FIELD OF THE INVENTION

This disclosure relates generally to an interfacing apparatus, and more particularly to an interfacing apparatus configured to interface with sensors.

### BACKGROUND OF THE INVENTION

Transducer systems are used for permanent monitoring applications in industrial equipment, such as turbomachinery. Transducers are installed in or on a turbomachine to make measurement pertaining to vibration, position, speed, pressure, torque, and power within the turbomachine and its components. Systems typically include a plurality of sensors mounted within or upon the turbomachine, and individually cabled or wired to a monitoring device. These sensors are each cabled to a probe that senses turbomachine conditions and transmits this information to the monitoring device. The monitoring device then uses the information to make the above referenced measurements.

One issue with a typical transducer system pertains to the cost and difficulty involved with individually cabling each of the plurality of sensors to the monitoring device. Thus, it would be desirable to cable the plurality of sensors to the monitoring device in a manner that would reduce the cost and difficulty associated with today's systems.

### BRIEF DESCRIPTION OF THE INVENTION

Disclosed is an interfacing apparatus including an interfacing structure, at least one association region defined by the interfacing structure, the at least one association region configured for association with a sensor association region of at least one sensor, at least one electrical contact region disposed with the interfacing structure, the at least one electrical contact region being configured for electrical association with an electrical sensor contact region of the at least one sensor, a connector disposed with the interfacing structure, the connector configured for connection to a monitoring device, and a signal router disposed in the interfacing structure, the signal router configured to electrically associate the at least one electrical contact region with the connector.

Also disclosed is an interfacing apparatus including an interfacing structure, at least one association region defined by the interfacing structure, a sensor association region of at least one sensor associating with the at least one association region to mount the at least one sensor to the interfacing structure, at least one electrical contact region disposed with the interfacing structure, the at least one electrical contact region being configured for electrical association with an electrical sensor contact region of the at least one sensor, a connector disposed with the interfacing structure, the connector configured for connection to a monitoring device, and a signal router disposed in the interfacing structure, the signal router configured to electrically associate the at least one electrical contact region with the connector.

Further disclosed is a method for mounting sensors on interfacing apparatus, said method including associating at least one sensor with at least one association region of an interfacing structure, electrically associating a sensor contact region of the at least one sensor with at least one electrical contact region of the interfacing structure, linking the at least one electrical contact region with a connector via a signal router disposed with the interfacing structure, and cabling the connector disposed on the interfacing structure with a monitoring device.

### BRIEF DESCRIPTION OF THE DRAWINGS

The foregoing and other features and advantages of the present invention should be more fully understood from the following detailed description of illustrative embodiments taken in conjunction with the accompanying Figures in which like elements are numbered alike in the several Figures:

FIG. 1 is a perspective schematic view of an interfacing apparatus;

FIG. 2 is a top schematic view, partly in section, of the interfacing apparatus of FIG. 1 including a housing; and

FIG. 3 is a block diagram illustrating a method for mounting sensors on an interfacing apparatus.

### DETAILED DESCRIPTION OF THE INVENTION

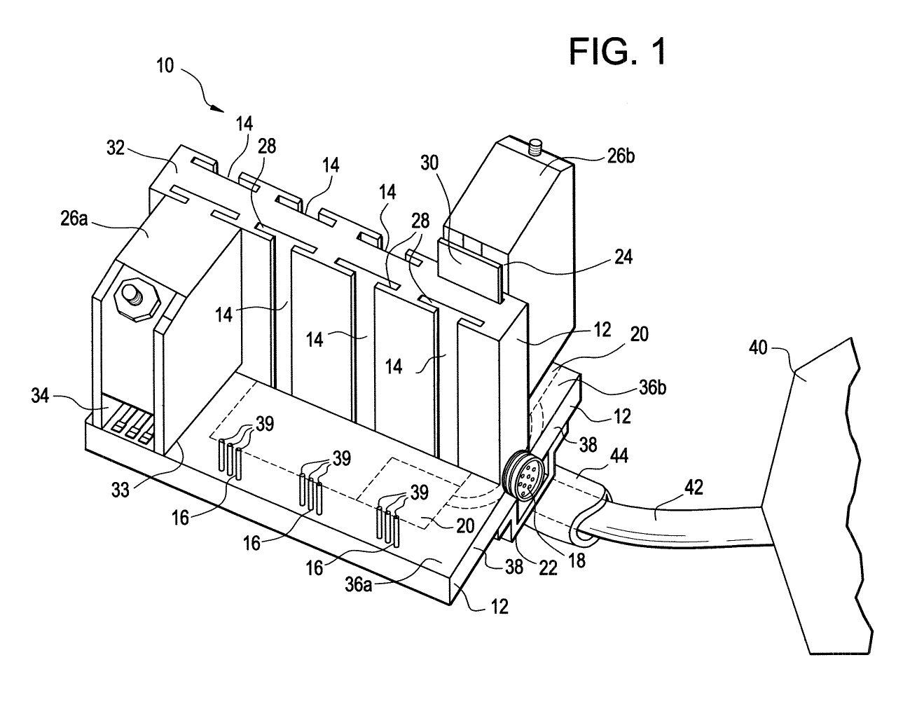

Referring to FIG. 1, an interfacing apparatus 10 is illustrated. The apparatus 10 includes an interfacing structure 12, which defines at least one association region 14, and includes at least one electrical contact region 16, a connector 18, and a signal router 20. In addition, the apparatus 10 may include a rail mount 22, disposed on the interfacing structure 12.

With the components of the interfacing apparatus 10 having been briefly introduced, a more detailed description of each will now follow, beginning with the association regions 14. The association regions 14 are each configured to associate with a sensor association region 24 of each of at least one sensor 26a-b. In an exemplary embodiment, the association regions 14 may comprise T-shaped grooves 28 defined by the interfacing structure 12.

Each of these grooves 28 receives a T-structure 30 of the sensors 26a-b and located in the sensor association regions 24. Employing the T-structure 30 and groove 28 to associate each of the sensors 26a-b with the interfacing structure 12 may be accomplished by inserting/sliding the T-structures 30 of each sensor 26a-b into the grooves 28 from a relative top 32 of the interfacing structure 12.

When the sensors 26a-b are received in a desired, fully seated position 33 (like sensor 26a in FIG. 1), each sensor 26a-b may be retained in association with the interfacing structure 12 via a locking means such as a spring biased retaining clip (the locking means is not shown in the Figures). It should be appreciated that the sensors 26a-b discussed above and hereinbelow may be of any type, including proximity, pressure, and acceleration sensors used in transducer systems, such as a Proximitor® probe available from Bently Nevada.

It should also be appreciated that when each of the sensors 26a-b is disposed in the fully associated position 33, there is contact between the electrical contact regions 16 of the interfacing structure 12 and an electrical sensor contact regions 34 of each sensor 26a-b. In an exemplary embodiment, the electrical contact regions 16 are located on each side 36a-b of a contact portion 38 of the interfacing structure 12, and comprise at least one contact terminal 39. The contact regions 16 will be configured with the contact portion 38 so as to allow contact between the contact points 39 and the sensor contact regions 34 when each sensor 26a-b is disposed in the fully associated position 33. When the contact terminal 39 and sensor contact regions 34 are in contact, each sensor 26a-b may electrically pass information to the contact region 16 of the interfacing structure 12.

Electrically associated with the contact terminal 39 of the contact region 16 is the signal router 20, which may be a circuit board. Sensor information transmitted from the sensor contact regions 34 to the contact regions 16 via contact with the contact terminals 39 is electronically transmissible to the signal router 20. The signal router 20 may be disposed within the interfacing structure 12, and is electronically associated with the connector 18 as well as the contact regions 16. Thus, information from the sensors 26a-b is transmissible from the contact regions 16 to the connector 18 via the signal router 20. The signal router 20 may be in the form of a PCB, bread board or wiring harness.

The connector 18 is electronically connected to the signal router 20, and by extension with the contact regions 16 and sensors 26a-b. The connector 18 may be a DSUB connector, circular connector (as shown in the Figures), pin and socket connector, or any other suitable connector type. The connector 18 is associable with a monitoring device 40 via a wire or cable 42. Cabling the connector 18 with the monitoring device 40 allows information from each sensor 26a-b associated with the interfacing structure 12 (in the fully associated position 33 of sensor 26a) to be transmitted from the sensors 26a-b, into the contact regions 16, through the signal router 20, to the connector 18, and ultimately to the monitoring device 40.

Thus, each sensor 26a-b fully associated with the apparatus 10, is effectively in electrical communication with the monitoring device 40 via its association with the apparatus 10. Associating the sensors 26a-b with the apparatus 10 allows each sensor 26a-b to be free of individual cabling with the monitoring device 40. The one cable 42 extending from the connector 18 to the monitoring device 40 takes the place of multiple cables and cablings that would have been necessary for individually cabling each of the sensors 26a-b. This greatly decreases the cost and difficulty associated multiple cablings. It should be appreciated that while FIG. 1 shows an apparatus 10 capable of interfacing with eight sensors like sensors 26a-b, an apparatus 10 may be configured to associate with as many sensors as is desirable for an application, with each sensor being cabled to the monitoring system 40 via the cable connection between the apparatus 10 and the monitoring system 40.

As was briefly mentioned above, it should be appreciated that the apparatus 10 may also include a rail mount 22. The rail mount would be attached to the interfacing structure 12, and be associable with a rail 44. Associating the rail mount 22 with the rail 44 allows the apparatus 10 to be mounted within a turbomachine frame. The rail mount 22 may be any type of rail mounting structure desirable for an application, including a DIN rail mount.

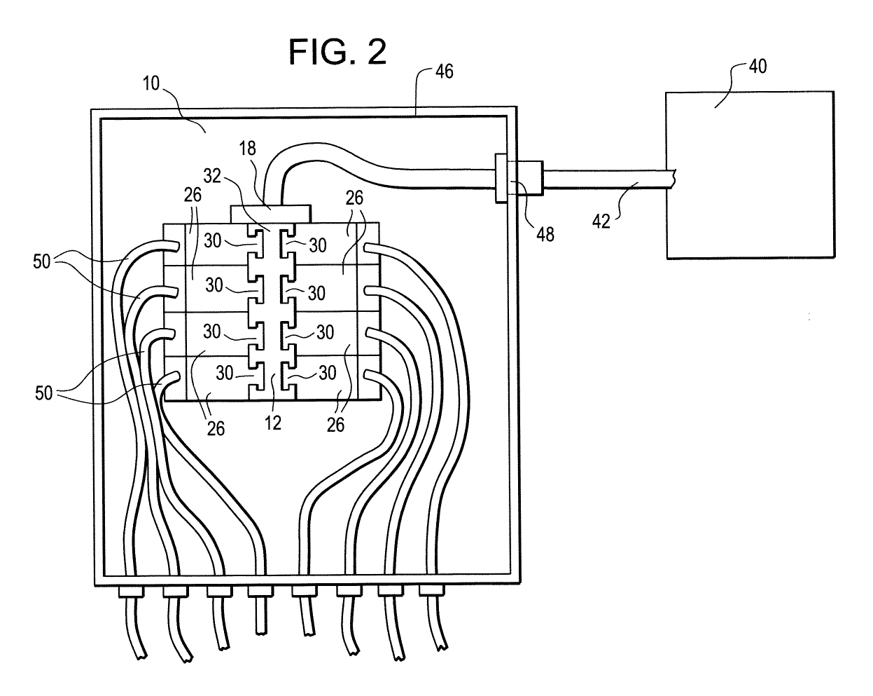

Referring now to FIG. 2, it should be appreciated that the apparatus may also include a housing 46 that will protect the apparatus from environmental conditions. The housing 46 houses the apparatus 10 and any sensor 26 (eight sensors 26 being shown) associated with the apparatus 10. The housing 46 also includes a cable cavity 48, configured to allow cable 42 access to the connector 18, while allowing the connector 18 to be housed and protected within the housing 46. FIG. 2 additionally illustrates probe cables 50 that associate each sensor 26 with a probe (not illustrated) disposed outside of the housing 46, wherein the probes sense turbomachine conditions.

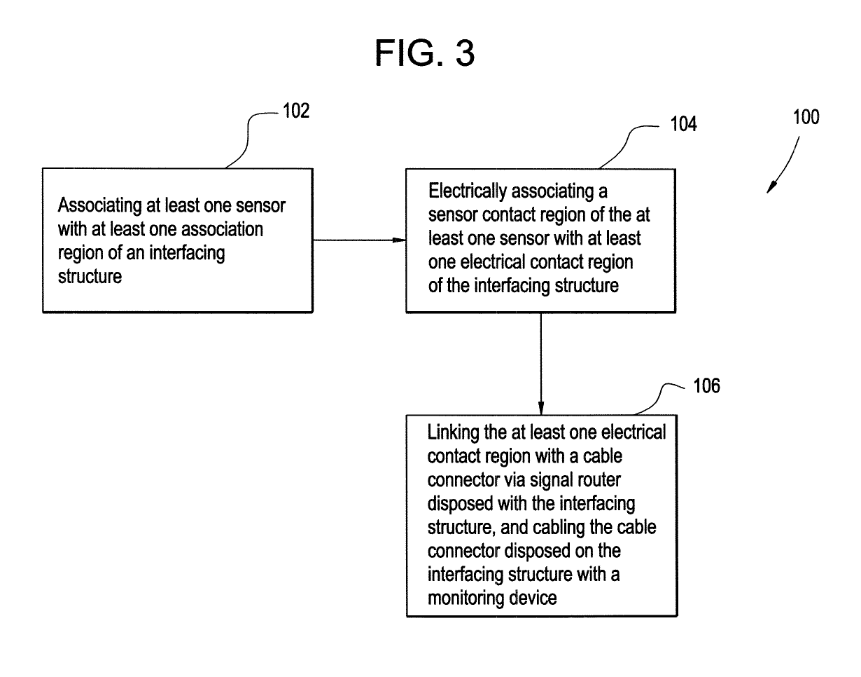

Referring now to FIG. 3, a method 100 for mounting sensors on interfacing apparatus 10 is illustrated and includes associating at least one sensor 26a-b with at least one association region 14 of an interfacing structure 12, as shown in operational block 102. The method 100 also includes electrically associating a sensor contact region 34 of the at least one sensor 26a-b with at least one electrical contact region 16 of the interfacing structure 12, as is shown in operational block 104. The method 100 further includes linking the at least one electrical contact region 16 with a connector 18 via a signal router 20 disposed with the interfacing structure 12, and cabling the connector 18 disposed on the interfacing structure 12 with a monitoring device 40, as shown in operational block 106.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. An interfacing apparatus comprising:
an interfacing structure;
at least one association region defined by said interfacing structure, said at least one association region configured for association with a sensor association region of at least one sensor;
at least one electrical contact region disposed with said interfacing structure, said at least one electrical contact region being configured for electrical association with an electrical sensor contact region of said at least one sensor;
a connector disposed with said interfacing structure, said connector configured for connection to a monitoring device; and
a signal router disposed in said interfacing structure, said signal router configured to electrically associate said at least one electrical contact region with said connector.

2. An apparatus according to claim 1, wherein said at least one association region is at least one groove defined by said interfacing structure.

3. An apparatus according to claim 2, wherein said at least one groove is associable with a T-structure defined by said at least one sensor.

4. An apparatus according to claim 1, further including a rail mount disposed on said interfacing structure, said rail mount being associable with a rail.

5. An apparatus according to claim 1, further including a housing that is configured to house said interfacing structure and said at least one sensor associated with said interfacing structure, said housing defining a cable cavity for accessing said connector.

6. An apparatus according to claim 1, wherein said at least one sensor is at least one of a proximity, pressure, and acceleration sensor used in a transducer system.

7. An apparatus according to claim 1, wherein said signal router is a circuit board.

8. An apparatus according to claim 1, wherein said at least one sensor is mounted to said interfacing structure.

9. An interfacing apparatus comprising:
an interfacing structure;
at least one association region defined by said interfacing structure;
a sensor association region of at least one sensor associating with said at least one association region to mount said at least one sensor to said interfacing structure;
at least one electrical contact region disposed with said interfacing structure, said at least one electrical contact region being configured for electrical association with an electrical sensor contact region of said at least one sensor;
a connector disposed with said interfacing structure, said connector configured for connection to a monitoring device; and
a signal router disposed in said interfacing structure, said signal router configured to electrically associate said at least one electrical contact region with said connector.

10. A method for mounting sensors on interfacing apparatus, said method comprising:
associating at least one sensor with at least one association region of an interfacing structure;
electrically associating a sensor contact region of said at least one sensor with at least one electrical contact region of said interfacing structure;
linking said at least one electrical contact region with a connector via a signal router disposed with said interfacing structure; and
cabling said connector disposed on said interfacing structure with a monitoring device.

11. A method according to claim 8, further including parametrically housing said interfacing structure and said at least one sensor associated with said interfacing structure via a housing.

12. A method according to claim 8, further including disposing the said interfacing structure on a rail via a rail mount.
